(19) United States
(12) Patent Application Publication
(10) Pub. No.: US 2022/0404558 A1
(43) Pub. Date: Dec. 22, 2022

(54) OPTICAL MODULE AND OPTICAL UNIT

(71) Applicant: KYOCERA Corporation, Kyoto-shi, Kyoto (JP)

(72) Inventors: Tomoyoshi AKASHI, Kitami-shi (JP); Michifumi SHODA, Soraku-gun (JP)

(73) Assignee: KYOCERA Corporation, Kyoto-shi, Kyoto (JP)

(21) Appl. No.: 17/638,524

(22) PCT Filed: Aug. 20, 2020
(86) PCT No.: PCT/JP2020/031418

§ 371 Date: Feb. 25, 2022

(30) Foreign Application Priority Data
Aug. 28, 2019 (JP) 2019-155829

(51) Int. Cl. G02B 6/38

(52) U.S. Cl. CPC G02B 6/3853

(57) ABSTRACT

An optical module includes first and second optical fibers, and first and second optical fiber collimators, that are arranged in a light path. The first optical fiber collimator has a first core and a first cladding layer surrounding the first core. The second optical fiber collimator has a second core and a second cladding layer surrounding the second core. The first optical fiber has a third core. The second optical fiber has a fourth core. When the third core has a diameter smaller than the fourth core, a refractive-index difference between the first core and the first cladding layer is larger than that between the second core and the second cladding layer. When the third core has a core diameter larger than the fourth core, the refractive-index difference between the first core and the first cladding layer is smaller than that between the second core and the second cladding layer.

### CROSS-REFERENCE TO RELATED APPLICATIONS

The present application claims priority from Japanese Patent Application No. 2019-155829 (filed on Aug. 28, 2019), the entire contents of which are hereby incorporated by reference.

### TECHNICAL FIELD

The present disclosure relates to optical modules and optical units.

### BACKGROUND ART

In an optical communication system, optical fibers with a uniform core diameter have been used as an optical-signal input optical fiber and an optical-signal output optical fiber so that a mode field diameter (MFD) of light traveling through a core is made uniform. In order to couple light output from the input optical fiber to the output optical fiber, a pair of lenses having the same radius of curvature and the same refractive index have been used as a collimator.

However, for example, in a case where the input optical fiber is to receive light from a light source equipped in a substrate having a fine optical waveguide, as in silicon photonics, the input optical fiber used needs to be an optical fiber having a core diameter that corresponds to the core diameter of the optical waveguide. In other words, the input and output optical fibers used need to be optical fibers that allow light having different MFDs to travel therethrough. If light having an MFD that does not correspond to the core diameter of the output optical fiber enters the output optical fiber, an optical coupling loss occurs. Cited Document 1 (Japanese Unexamined Patent Application Publication No. 5-113518) discloses an optical-fiber coupling lens system that uses a pair of spherical lenses having different radii of curvature as a collimator and in which the MFD of light output from the input optical fiber corresponds to the MFD of the output optical fiber.

### SUMMARY OF INVENTION

An optical module according to an embodiment of the present disclosure includes a first optical fiber, a first optical fiber collimator, a second optical fiber collimator, and a second optical fiber that are sequentially arranged in a first direction as a direction of a light path. The first optical fiber collimator has a first core and a first cladding layer surrounding an outer periphery of the first core. The second optical fiber collimator has a second core and a second cladding layer surrounding an outer periphery of the second core. The first optical fiber has a third core. The second optical fiber has a fourth core. The third core has a core diameter smaller than a core diameter of the fourth core. A difference between a refractive index of the first core and a refractive index of the first cladding layer is larger than a difference between a refractive index of the second core and a refractive index of the second cladding layer.

An optical module according to an embodiment of the present disclosure includes a first optical fiber, a first optical fiber collimator, a second optical fiber collimator, and a second optical fiber that are sequentially arranged in a first direction as a direction of a light path. The first optical fiber collimator has a first core and a first cladding layer surrounding an outer periphery of the first core. The second optical fiber collimator has a second core and a second cladding layer surrounding an outer periphery of the second core. The first optical fiber has a third core. The second optical fiber has a fourth core. The third core has a core diameter larger than a core diameter of the fourth core. A difference between a refractive index of the first core and a refractive index of the first cladding layer is smaller than a difference between a refractive index of the second core and a refractive index of the second cladding layer.

An optical unit according to an embodiment of the present disclosure includes the optical module having the above-described configuration and an external substrate connected to the optical module.

### BRIEF DESCRIPTION OF DRAWINGS

FIG. 1 is a perspective view of an optical module according to an embodiment of the present disclosure.

FIG. 2 is a cross-sectional view taken in a first direction of the optical module in FIG. 1.

FIG. 3A is a perspective view of an optical module according to another embodiment of the present disclosure.

FIG. 3B is a perspective view of an optical module obtained by equipping the optical module in FIG. 3A with an element.

FIG. 4A is an example of a cross-sectional view taken in the first direction of the optical module in FIG. 3A.

FIG. 4B is another example of a cross-sectional view taken in the first direction of the optical module in FIG. 3A.

FIG. 4C is a cross-sectional view illustrating the optical module in FIG. 4B equipped with the element.

FIG. 5A is an example of an enlarged view of an area V in FIG. 4C.

FIG. 5B is another example of an enlarged view of the area V in FIG. 4C.

FIG. 6A is an enlarged view of a connection area between a first optical fiber and a first optical fiber collimator.

FIG. 6B is an enlarged view of a connection area between a second optical fiber and a second optical fiber collimator.

FIG. 7 is a perspective view of an optical module according to another embodiment of the present disclosure.

FIG. 8 is a cross-sectional view taken in the first direction of the optical module in FIG. 7.

FIG. 9 is a perspective view of an optical module according to another embodiment of the present disclosure.

FIG. 10A is an example of a cross-sectional view taken in the first direction in FIG. 9.

FIG. 10B is another example of a cross-sectional view taken in the first direction in FIG. 9.

FIG. 11 is a perspective view of an optical module according to another embodiment of the present disclosure.

FIG. 12 is a cross-sectional view taken in the first direction of the optical module in FIG. 11.

FIG. 13 is a perspective view of an optical unit according to an embodiment of the present disclosure.

### DESCRIPTION OF EMBODIMENTS

Embodiments will now be described in detail below with reference to the drawings. Each drawing is given XYZ orthogonal coordinates in which a first direction is defined as an X-axis direction. The first direction may sometimes be described below as the X-axis direction.

[Embodiment of Optical Module]

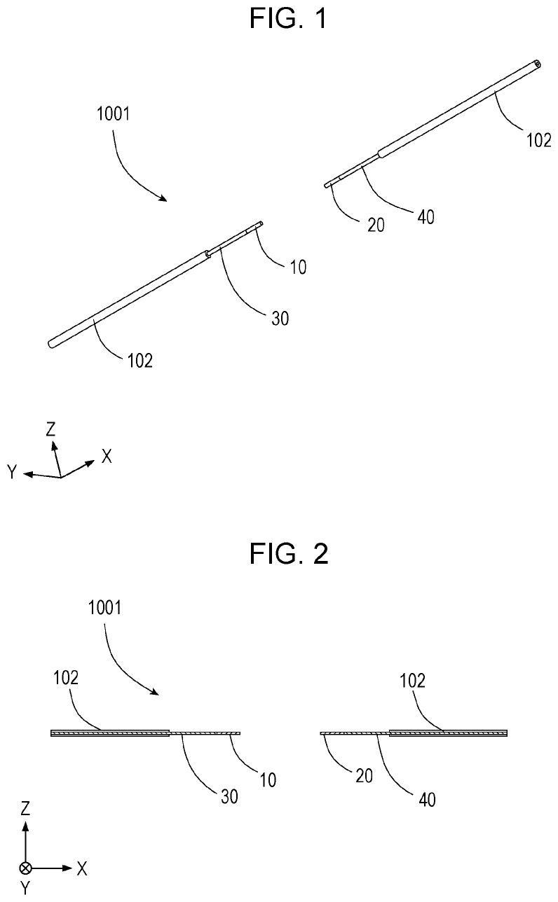

An optical module 1001 shown in FIGS. 1 and 2 includes a first optical fiber 30, a first optical fiber collimator 10, a second optical fiber collimator 20, and a second optical fiber 40 that are sequentially arranged in the first direction as a direction of a light path. The first optical fiber collimator 10 has a first core 11 and a first cladding layer 12 surrounding the outer periphery of the first core 11. The second optical fiber collimator 20 has a second core 21 positioned away from the first core 11 and a second cladding layer 22 surrounding the outer periphery of the second core 21. The first optical fiber 30 has a third core 31. The second optical fiber 40 has a fourth core 41. The first optical fiber collimator 10 further has a first end surface 13 located at the front side in the first direction. The second optical fiber collimator 20 further has a third end surface 23 located at the rear side in the first direction.

In this description, with regard to light traveling through each of the first optical fiber collimator 10, the second optical fiber collimator 20, the first optical fiber 30, and the second optical fiber 40, the side from which the light is output may sometimes be referred to as the front side in the first direction. Moreover, with regard to the light traveling through each of the first optical fiber collimator 10, the second optical fiber collimator 20, the first optical fiber 30, and the second optical fiber 40, the side from which the light is input may sometimes be referred to as the rear side in the first direction.

In the optical module 1001 according to the present disclosure, light from an external light source, such as a laser diode (LD), first enters the third core 31 of the first optical fiber 30, and the light output from the third core 31 enters the first core 11 of the first optical fiber collimator 10. Subsequently, the light output from the first core 11 enters the second core 21 of the second optical fiber collimator 20, and the light output from the second core 21 enters the fourth core 41 of the second optical fiber 40. Then, the light output from the fourth core 41 enters an external optical component where exchanging of an optical signal is performed. In this description, the direction of the path of light input to the optical module 1001 and output from the optical module 1001 is referred to as the first direction. The first direction merely indicates the directional property and does not imply that the light strictly travels along a straight line.

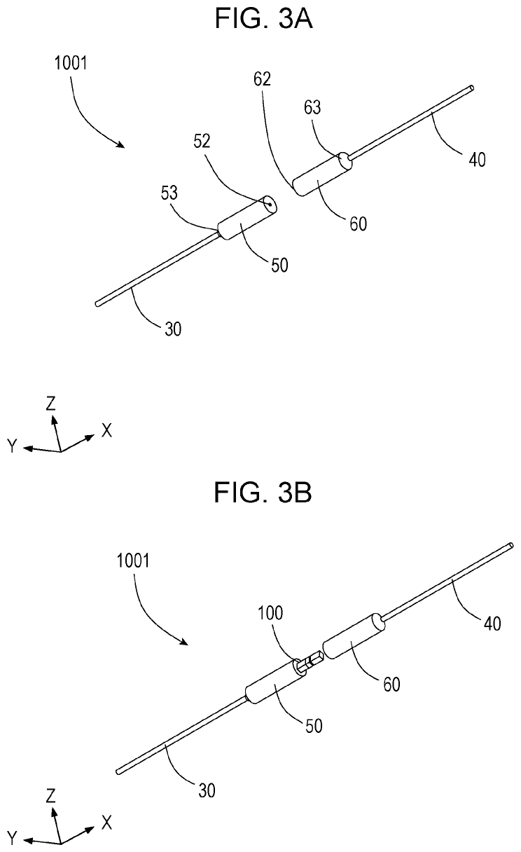

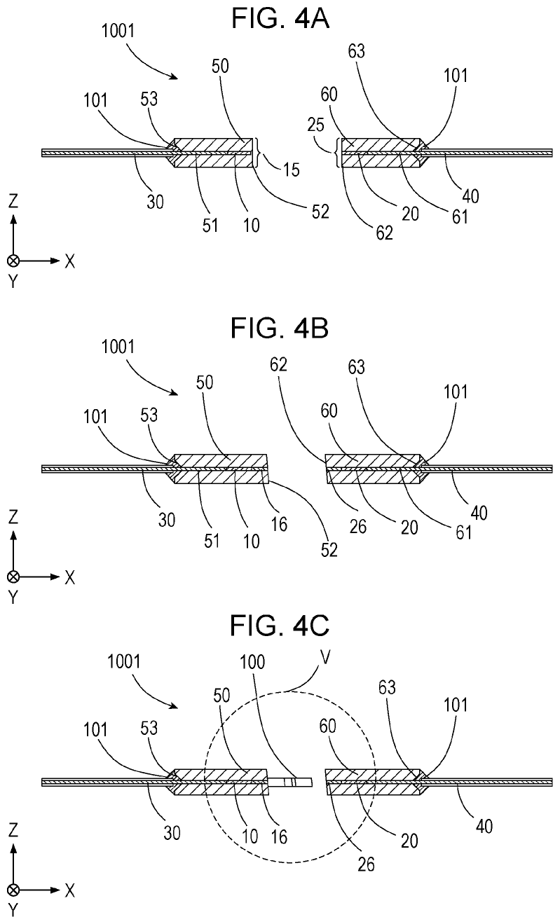

For example, as shown in FIGS. 3A, 3B, 4A, 4B, and 4C, the optical module 1001 may further include a first ferrule 50 and a second ferrule 60. The first ferrule 50 has a first through-hole 51 and a second end surface 52 located at the front side in the first direction. The second ferrule 60 has a second through-hole 61 and a fourth end surface 62 located at the rear side in the first direction. As shown in FIGS. 3B and 4C, the optical module 1001 may include an element 100.

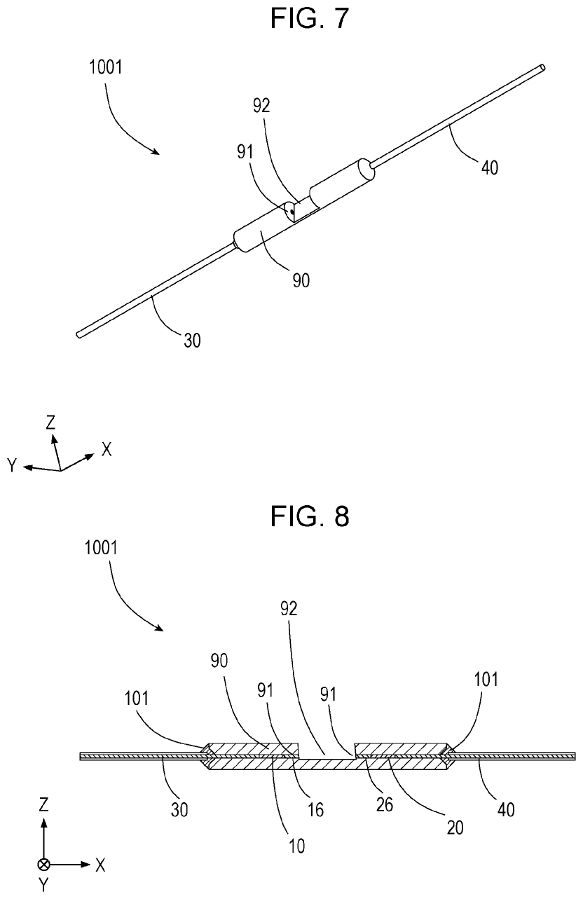

Furthermore, as shown in FIG. 7, the optical module 1001 may further include a third ferrule 90. The third ferrule 90 has a third through-hole 91 and a hole 92 connecting to the third through-hole 91 from the outer periphery of the third ferrule 90.

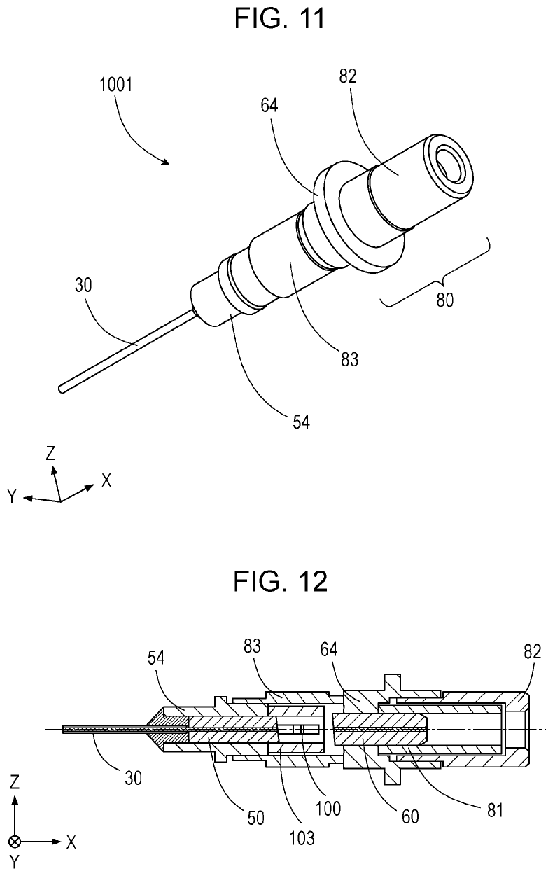

When the optical module 1001 has the first ferrule 50 and the second ferrule 60, the optical module 1001 may further include a receptacle 80, as shown in FIGS. 11 and 12.

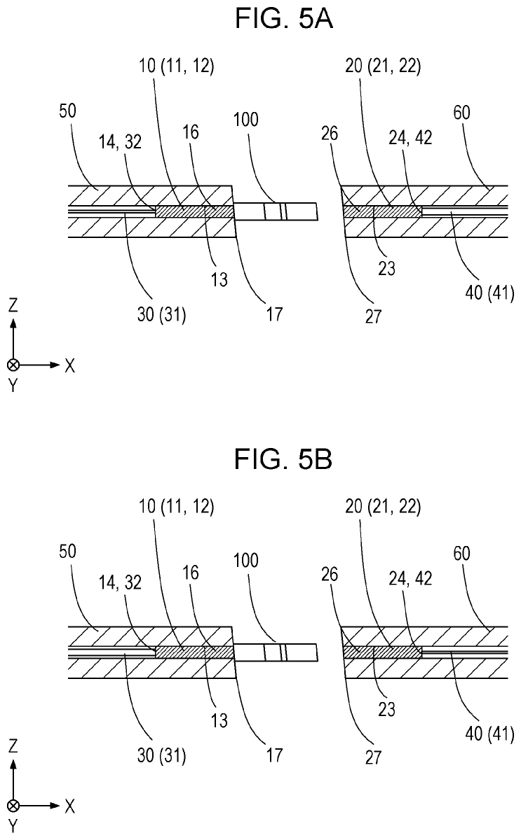

In the optical module 1001 shown in FIG. 5A, the core diameter of the third core 31 is smaller than the core diameter of the fourth core 41. In such a configuration, the difference between the refractive index of the first core 11 and the refractive index of the first cladding layer 12 is larger than the difference between the refractive index of the second core 21 and the refractive index of the second cladding layer 22, so that light with an MFD corresponding to the core diameter of the third core 31 can be matched with an MFD corresponding to the core diameter of the fourth core 41. Thus, when light output from the first optical fiber 30 is to enter the second optical fiber 40, the optical module 1001 can reduce a coupling loss. In detail, the MFD of the light output from the third core 31 is expanded in correspondence with the core diameter of the fourth core 41 as a result of the light traveling through the first optical fiber collimator 10 and the second optical fiber collimator 20. The optical module 1001 having such a configuration has excellent coupling efficiency.

Furthermore, in the optical module 1001 shown in FIG. 5B, the core diameter of the third core 31 is larger than the core diameter of the fourth core 41. In such a configuration, the difference between the refractive index of the first core 11 and the refractive index of the first cladding layer 12 is smaller than the difference between the refractive index of the second core 21 and the refractive index of the second cladding layer 22, so that light with an MFD corresponding to the core diameter of the third core 31 can be matched with an MFD corresponding to the core diameter of the fourth core 41. Thus, when light output from the first optical fiber 30 is to enter the second optical fiber 40, the optical module 1001 can reduce a coupling loss. In detail, the MFD of the light output from the third core 31 is reduced in correspondence with the core diameter of the fourth core 41 as a result of the light traveling through the first optical fiber collimator 10 and the second optical fiber collimator 20. The optical module 1001 having such a configuration has excellent coupling efficiency.

Furthermore, in the optical module 1001 according to the present disclosure, the first optical fiber collimator 10 and the second optical fiber collimator 20 are used as collimators. Therefore, the optical module 1001 is reduced in size, as compared with an optical module that uses, for example, a spherical lens larger in size than an optical fiber as a collimator.

The first core 11 in the first optical fiber collimator 10 may be in surface contact with the third core 31 in the first optical fiber 30. In other words, the first core 11 and the third core 31 may be in contact with each other. Moreover, the second core 21 in the second optical fiber collimator 20 may be in surface contact with the fourth core 41 in the second optical fiber 40. In other words, the second core 21 and the fourth core 41 may be in contact with each other. Accordingly, an optical loss at the boundary between the first optical fiber collimator 10 and the first optical fiber 30 and between the second optical fiber collimator 20 and the second optical fiber 40 can be reduced. The optical module 1001 having such a configuration has excellent optical properties.

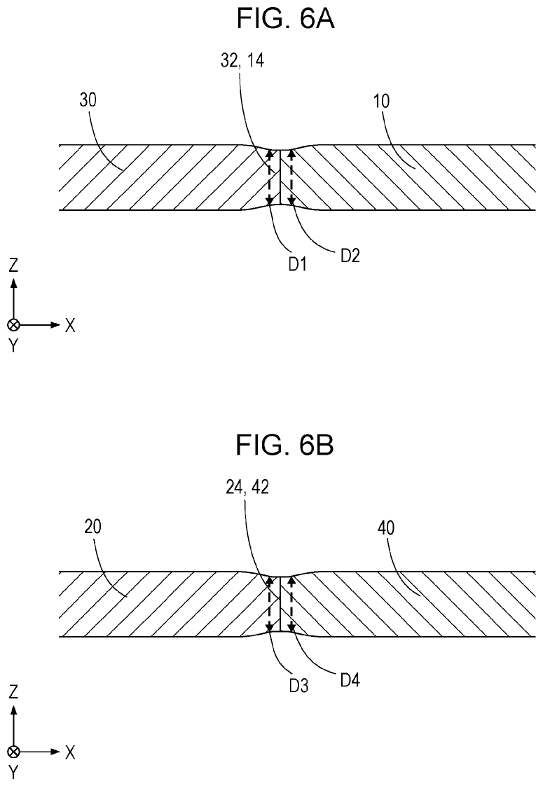

When the first core 11 and the third core 31 come into surface contact with each other, a diameter D1 of the first optical fiber 30 orthogonal to the first direction and a diameter D2 of the first optical fiber collimator 10 orthogonal to the first direction may be at a minimum at the boundary, as shown in FIG. 6A. Likewise, when the second core 21 and the fourth core 41 come into surface contact with each other, a diameter D3 of the second optical fiber collimator 20 orthogonal to the first direction and a diameter D4 of the second optical fiber 40 orthogonal to the first direction may be at a minimum at the boundary, as shown in FIG. 6B. Accordingly, an increase in outer diameter caused by misalignment when the first core 11 and the third core 31 are bonded to each other and when the second core 21 and the fourth core 41 are bonded to each other can be reduced. This also facilitates the insertion process for inserting the first optical fiber collimator 10, the second optical fiber collimator 20, the first optical fiber 30, or the second optical fiber 40 into the first ferrule 50, the second ferrule 60, or the third ferrule 90.

As shown in FIGS. 3A and 3B, when the optical module 1001 further includes the first ferrule 50 and the second ferrule 60, the first optical fiber 30 may be positioned within the first through-hole 51, and the second optical fiber 40 may be positioned within the second through-hole 61. Accordingly, the first optical fiber 30 and the second optical fiber 40 are less likely to be damaged by an external force. Moreover, the first optical fiber 30 or the second optical fiber 40 can be secured by the first ferrule 50 or the second ferrule 60.

Furthermore, as shown in FIGS. 4A, 4B, and 4C, the first optical fiber collimator 10 may further be positioned within the first through-hole 51, and the second optical fiber collimator 20 may further be positioned within the second through-hole 61. Accordingly, an occurrence of damage caused by an external force may also be reduced for the first optical fiber collimator 10 and the second optical fiber collimator 20.

As shown in FIG. 4A, the second end surface 52 and the first end surface 13 may be a common surface. In this case, the common surface will be referred to as a first surface 15. The first surface 15 may be a flat surface. The first surface 15 being a flat surface facilitates the positioning of the first optical fiber collimator 10 and the first optical fiber 30 in the X-axis direction within the first through-hole 51.

Likewise, the fourth end surface 62 and the third end surface 23 may be a common surface. In this case, the common surface will be referred to as a second surface 25. The second surface 25 may be a flat surface. The second surface 25 being a flat surface facilitates the positioning of the second optical fiber collimator 20 and the second optical fiber 40 in the X-axis direction within the second through-hole 61.

Furthermore, as shown in FIG. 4B, the first optical fiber collimator 10 may further have a first transparent member 16 that is in contact with the first end surface 13. In this case, the second end surface 52 and an end surface of the first transparent member 16 may be a common surface. The common surface will be referred to as a third surface 17. The third surface 17 may be a flat surface. In other words, the first transparent member 16 may be positioned at the first end surface 13 of the first optical fiber collimator 10 and be flush with the second end surface 52. Accordingly, when the third surface 17 is to be ground so as to be inclined relative to a direction orthogonal to the first direction, fine particles generated from the grinding are less likely to enter the first through-hole 51. As a result, absorption or reflection of light caused by fine particles located within the first through-hole 51 is reduced, whereby the optical module 1001 having such a configuration has excellent optical coupling efficiency. Moreover, abrasion of the first optical fiber collimator 10 is reduced during the grinding process of the third surface 17.

Likewise, the second optical fiber collimator 20 may further have a second transparent member 26 that is in contact with the third end surface 23. In this case, the fourth end surface 62 and an end surface of the second transparent member 26 may be a common surface. The common surface will be referred to as a fourth surface 27. The fourth surface 27 may be a flat surface. In other words, the second transparent member 26 may be positioned at the third end surface 23 of the second optical fiber collimator 20 and be flush with the fourth end surface 62. Accordingly, when the fourth surface 27 is to be ground so as to be inclined relative to the direction orthogonal to the first direction, fine particles generated from the grinding are less likely to enter the second through-hole 61. As a result, absorption or reflection of light caused by fine particles located within the second through-hole 61 is reduced, whereby the optical module 1001 having such a configuration has excellent optical coupling efficiency. Moreover, abrasion of the second optical fiber collimator 20 is reduced during the grinding process of the fourth surface 27.

When the third surface 17 is a flat surface, the third surface 17 may be inclined relative to the direction orthogonal to the first direction. In this case, the third surface 17 may be inclined at about 2° to 12°. Accordingly, the optical axis of reflection light at the end surface located at the front side of the first transparent member 16 in the first direction becomes inclined, so that feedback of light (feedback light) to, for example, the LD as a result of the reflection light coupling with the third core 31 is reduced. As a result, output fluctuations in, for example, the LD caused by feedback light are reduced.

Likewise, when the fourth surface 27 is a flat surface, the fourth surface 27 may be inclined relative to the direction orthogonal to the first direction. In this case, the fourth surface 27 may be inclined at about 2° to 12°. Accordingly, the optical axis of reflection light at the end surface located at the rear side of the second transparent member 26 in the first direction becomes inclined, so that feedback of light to, for example, the LD as a result of the reflection light coupling with the third core 31 is reduced. As a result, output fluctuations in, for example, the LD caused by feedback light are reduced.

The first surface 15 and the second surface 25, or the third surface 17 and the fourth surface 27, may be disposed parallel to each other. The optical module 1001 having such a configuration has high optical-axis controllability, and thus has excellent optical coupling efficiency.

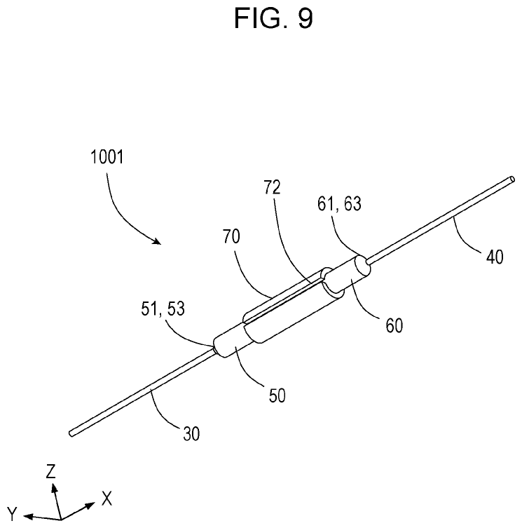

The optical module 1001 including the first ferrule 50 and the second ferrule 60 may further include a first sleeve 70, as shown in FIG. 9.

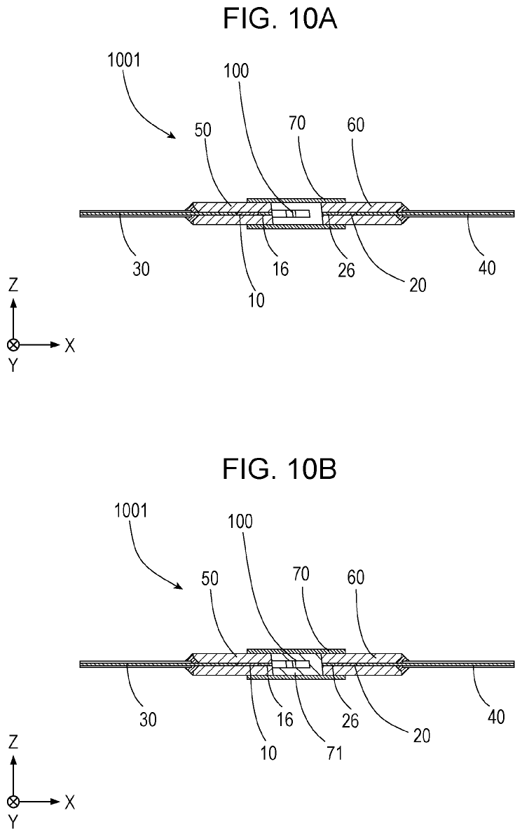

When the optical module 1001 includes the first sleeve 70, the first ferrule 50 and the second ferrule 60 may be retained away from each other within the first sleeve 70, as shown in FIGS. 10A and 10B. In other words, the first ferrule 50 and the second ferrule 60 are connected to the ends of the first sleeve 70 and are positioned away from each other. Accordingly, the first ferrule 50 and the second ferrule 60 can be positioned on the same axis, so that the optical module 1001 having such a configuration does not need alignment in the Z-axis direction.

Furthermore, as shown in FIG. 10B, a resin material 71 may be positioned within the first sleeve 70 and between the first ferrule 50 and the second ferrule 60. In this case, the resin material 71 is positioned on the light path between the first core 11 and the second core 21. Accordingly, the refractive index within the first sleeve 70 can be matched with the refractive index of the first optical fiber collimator 10 and the second optical fiber collimator 20 or the first transparent member 16 and the second transparent member 26, so that an occurrence of reflection caused by a refractive-index difference of light is reduced. The optical module 1001 having such a configuration has excellent optical properties.

The resin material 71 used may be, for example, acrylic-based resin, epoxy-based resin, vinyl-based resin, ethylene-based resin, silicone-based resin, urethane-based resin, polyamide-based resin, fluorine-based resin, polybutadiene-based resin, or polycarbonate-based resin. Of the aforementioned materials, acrylic-based resin and epoxy-based resin are superior in terms of moisture resistance, heat resistance, peel resistance, and shock resistance.

As shown in FIGS. 7 and 8, when the optical module 1001 includes the third ferrule 90, the first optical fiber 30, the first optical fiber collimator 10, the second optical fiber collimator 20, and the second optical fiber 40 are positioned within the third through-hole 91. Moreover, the hole 92 is located between the first optical fiber collimator 10 and the second optical fiber collimator 20 within the third through-hole 91. Accordingly, the first optical fiber collimator 10, the second optical fiber collimator 20, the first optical fiber 30, and the second optical fiber 40 are less likely to be damaged by an external force. Furthermore, because the first optical fiber collimator 10, the second optical fiber collimator 20, the first optical fiber 30, and the second optical fiber 40 can be secured within the third through-hole 91, the optical module 1001 having such a configuration enables easier optical-axis alignment.

When the optical module 1001 includes the element 100, the element 100 is positioned on the light path between the first core 11 and the second core 21. The element 100 may be an isolator element or a wavelength filter. The element 100 being an isolator element has less feedback light. The element 100 being a wavelength filter can selectively transmit light of a specific wavelength.

The element 100 may be positioned at the first surface 15, the second surface 25, the third surface 17, the fourth surface 27, the first end surface 13, or the third end surface 23. Accordingly, the element 100 is secured, so that the function of the element 100 becomes stable.

The element 100 may be positioned in the hole 92. Accordingly, the element 100 is secured, so that the function of the element 100 becomes stable.

[Optical Fiber Collimators]

The first optical fiber collimator 10 and the second optical fiber collimator 20 are optical fibers having the property of outputting a substantially collimated light beam with respect to input light. The first optical fiber collimator 10 and the second optical fiber collimator 20 used may each be, for example, a graded-index (GI) multimode optical fiber. A GI multimode optical fiber has a refractive-index distribution in which the refractive index of a core gradually decreases from the central axis of the fiber. A GI multimode optical fiber has a refractive-index distribution that is substantially the square of the distance from the central axis of the fiber. Therefore, by using a GI multimode optical fiber having an appropriate refractive-index distribution and an appropriate length, the GI multimode optical fiber can function as a collimator that outputs substantially-collimated light. Accordingly, the first optical fiber collimator 10 or the second optical fiber collimator 20, or both collimators can be disposed within the through-hole in the first ferrule 50, the second ferrule 60, or the third ferrule 90. As a result, the optical module 1001 is reduced in size, as compared with an optical module that uses, for example, a spherical lens as a collimator.

In a case where MFD matching is to be performed by using, for example, a spherical lens as a collimator, it is necessary to perform an adjustment by changing the radius of curvature of the spherical lens. Therefore, the size of the spherical lens changes in accordance with the adjustment of the radius of curvature. In contrast, the first optical fiber collimator 10 and the second optical fiber collimator 20 can maintain the diameters thereof equal to the diameters of the first optical fiber 30 and the second optical fiber 40. The refractive-index differences between the first core 11 and the first cladding layer 12 and between the second core 21 and the second cladding layer 22 can be adjusted. In other words, in the present disclosure, MFD matching can be performed without changing the size of each collimator.

Each of the first optical fiber collimator 10 and the second optical fiber collimator 20 may have, for example, a cylindrical shape, and may have a diameter of ϕ0.08 mm to ϕ0.128 mm and a length of 0.5 mm to 2.0 mm in the first direction. In the case where the first optical fiber 30 and the first optical fiber collimator 10 are in contact with each other, the diameter D1 of the first optical fiber collimator 10 may be at a minimum at the boundary between the first optical fiber 30 and the first optical fiber collimator 10. In this case, the diameter D1 may be smaller than other sections by about 5 μm or smaller.

In the case where the second optical fiber 40 and the second optical fiber collimator 20 are in contact with each other, the diameter D2 of the second optical fiber collimator 20 may be at a minimum at the boundary between the second optical fiber 40 and the second optical fiber collimator 20. In this case, the diameter D2 may be smaller than other sections by about 5 μm or smaller.

The refractive index of the first core 11 that the first optical fiber collimator 10 has and the refractive index of the second core 21 that the second optical fiber collimator 20 has are higher than the refractive index of the first cladding layer 12 surrounding the outer periphery of the first core 11 and the refractive index of the second cladding layer 22 surrounding the outer periphery of the second core 21. Accordingly, light is continuously refracted at the axial center of each of the first optical fiber collimator 10 and the second optical fiber collimator 20, so that the light can be made to propagate only to the first core 11 and the second core 21.

The core diameter of each of the first core 11 and the second core 21 may be about ϕ0.05 mm to ϕ0.125 mm. A beam waist ω1 (i.e., a beam waist of the first optical fiber collimator 10) and a beam waist ω2 (i.e., a beam waist of the second optical fiber collimator 20) of light changed into substantially-collimated light by the first optical fiber collimator 10 and the second optical fiber collimator 20 may be about ϕ0.01 mm to ϕ0.1 mm. With ω1 and ω2 being equal to each other, when light output from the first optical fiber 30 travels through the second optical fiber collimator 20 via the first optical fiber collimator 10, an optical coupling loss can be reduced.

The refractive-index difference between the first core 11 and the first cladding layer 12 and the refractive-index difference between the second core 21 and the second cladding layer 22 may be about Δ0.5% to Δ5%. When the MFD of the first optical fiber 30 and the MFD of the second optical fiber 40 are different from each other, ω1 and ω2 can be made equal to each other by changing a refractive-index difference.

The first core 11 and the second core 21 may be disposed away from each other by about 0.5 mm to 3 mm. This space functions as a focal length of the first optical fiber collimator 10 and the second optical fiber collimator 20.

For example, the first end surface 13 that the first optical fiber collimator 10 has may be a flat surface and may intersect the direction orthogonal to the first direction. Moreover, the first optical fiber collimator 10 may have a first other-end surface 14 at the rear side in the first direction. Similar to the first end surface 13, for example, the first other-end surface 14 may be a flat surface and may intersect the direction orthogonal to the first direction.

For example, the third end surface 23 that the second optical fiber collimator 20 has may be a flat surface and may intersect the direction orthogonal to the first direction. Furthermore, the second optical fiber collimator 20 may have a third other-end surface 24 at the rear side in the first direction. Similar to the third end surface 23, for example, the third other-end surface 24 may be a flat surface and may intersect the direction orthogonal to the first direction.

Each of the first transparent member 16 and the second transparent member 26 may have, for example, a cylindrical shape, and may have a diameter of ϕ0.3 mm to ϕ2.5 mm.

The first transparent member 16 and the second transparent member 26 may be composed of glass. If glass is used, the refractive-index difference at the connection area between the first optical fiber collimator 10 and the second optical fiber collimator 20 can be reduced, so that reflection light is less likely to occur, whereby an occurrence of feedback light can be reduced.

The first optical fiber collimator 10 and the first transparent member 16, as well as the second optical fiber collimator 20 and the second transparent member 26, may be joined together by using an adhesive 101, or may be thermally fused together.

The adhesive 101 used may be, for example, acrylic-based resin, epoxy-based resin, vinyl-based resin, ethylene-based resin, silicone-based resin, urethane-based resin, polyamide-based resin, fluorine-based resin, polybutadiene-based resin, or polycarbonate-based resin. Of the aforementioned materials, acrylic-based resin and epoxy-based resin are superior in terms of moisture resistance, heat resistance, peel resistance, and shock resistance.

A reflection reducing material may be positioned at each of the first surface 15, the second surface 25, the third surface 17, and the fourth surface 27. Accordingly, the effect of reflection can be reduced. The reflection reducing material used may be, for example, titanium dioxide (TiO₂), silicon dioxide (SiO₂), or tantalum pentoxide (Ta₂O₅).

[Optical Fibers]

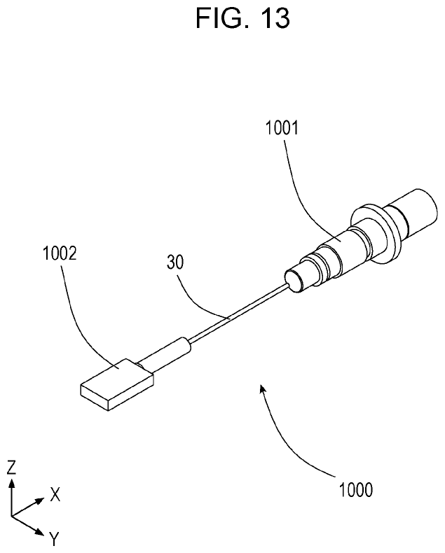

The first optical fiber 30 introduces light from an external light source, such as an LD, to the optical module 1001. By using the first optical fiber 30, for example, if a light source, such as an LD, is installed on an external substrate 1002 shown in FIG. 13, the degree of freedom of installation can be enhanced. The second optical fiber 40 is used for, for example, connecting to another optical component.

The first optical fiber 30 and the second optical fiber 40 used may each be, for example, a quartz-based optical fiber, a plastic-based optical fiber, or a multicomponent-glass-based optical fiber. Moreover, the first optical fiber 30 and the second optical fiber 40 used may each be an optical fiber according to the JIS standard or TIA/EIA standard.

Each of the first optical fiber 30 and the second optical fiber 40 may have, for example, a cylindrical shape, and may have a diameter of ϕ0.08 mm to ϕ0.128 mm and a length of 10 mm to 300 mm in the first direction. In the case where the first optical fiber 30 and the first optical fiber collimator 10 are in contact with each other, the diameter D3 of the first optical fiber 30 may be at a minimum at the boundary between the first optical fiber 30 and the first optical fiber collimator 10. In this case, the diameter D3 of the first optical fiber 30 may be smaller than other sections by about ϕ5 μm or smaller. In the case where the second optical fiber 40 and the second optical fiber collimator 20 are in contact with each other, the diameter D4 of the second optical fiber 40 may be at a minimum at the boundary between the second optical fiber 40 and the second optical fiber collimator 20. In this case, the diameter D4 of the second optical fiber 40 may be smaller than other sections by about ϕ5 μm or smaller.

The refractive index of the third core 31 that the first optical fiber 30 has and the refractive index of the fourth core 41 that the second optical fiber 40 has are higher than the refractive index of a third cladding layer surrounding the outer periphery of the third core 31 and the refractive index of a fourth cladding layer surrounding the outer periphery of the fourth core 41. Accordingly, total reflection or refraction is performed, so that light traveling through the first optical fiber 30 and the second optical fiber 40 can be made to propagate only to the third core 31 or the fourth core 41.

A core diameter ϕ4 of the third core 31 and a core diameter ϕ3 of the fourth core 41 may be, for example, ϕ0.002 mm to ϕ0.01 mm. Furthermore, for example, the MFD of light traveling through the third core 31 may be ϕ0.002 mm to ϕ0.01 mm, and the MFD of light traveling through the fourth core 41 may be ϕ0.002 mm to ϕ0.01 mm.

Of the end surfaces of the first optical fiber 30, for example, a fifth end surface 32 in contact with the first other-end surface 14 may be a flat surface and may intersect the direction orthogonal to the first direction. Accordingly, when the first other-end surface 14 and the fifth end surface 32 are connected to each other, misalignment of the connection surfaces is less likely to occur. Likewise, of the end surfaces of the second optical fiber 40, for example, a sixth end surface 42 in contact with the third other-end surface 24 may be a flat surface and may intersect the direction orthogonal to the first direction. Accordingly, when the third other-end surface 24 and the sixth end surface 42 are connected to each other, misalignment of the connection surfaces is less likely to occur.

The first other-end surface 14 and the fifth end surface 32, as well as the third other-end surface 24 and the sixth end surface 42, may be thermally fused together, or may be connected by using the adhesive 101.

The outer periphery of each of the first optical fiber 30 and the second optical fiber 40 may be covered with a coating 102. By being covered with the coating 102, each of the first optical fiber 30 and the second optical fiber 40 can reduce an occurrence of damage caused by external pressure. In a case where the first optical fiber 30 or the second optical fiber 40 is to be inserted into the first ferrule 50, the second ferrule 60, or the third ferrule 90, the insertion is performed by peeling off the coating 102.

[Ferrules]

The first ferrule 50, the second ferrule 60, and the third ferrule 90 are used for securing and connecting, for example, the first optical fiber collimator 10, the second optical fiber collimator 20, the first optical fiber 30, or the second optical fiber 40.

As shown in FIGS. 3A and 3B, the optical module 1001 includes the first ferrule 50 and the second ferrule 60 so that the first ferrule 50 or the second ferrule 60 or both of the ferrules can be moved in three-dimensional directions. As a result, light output after traveling through the first optical fiber 30 and the first optical fiber collimator 10 within the first ferrule 50 can be aligned to enter the second optical fiber collimator 20.

The first ferrule 50, the second ferrule 60, and the third ferrule 90 may have, for example, a cylindrical shape or a prismatic shape. Furthermore, the first ferrule 50 and the second ferrule 60 may have, for example, a diameter of ϕ0.3 mm to ϕ2.5 mm and a length of 2.0 mm to 10 mm in the first direction. The third ferrule 90 may have a diameter of ϕ0.3 mm to ϕ2.5 mm and a length of 4.0 mm to 20 mm in the first direction.

The first through-hole 51, the second through-hole 61, and the third through-hole 91 may have, for example, a diameter of ϕ0.08 mm to ϕ0.128 mm and a length of 2.0 mm to 10 mm in the first direction. The diameters of the through-holes can be appropriately set in accordance with the diameters of the first optical fiber collimator 10, the second optical fiber collimator 20, the first optical fiber 30, and the second optical fiber 40 positioned within the through-holes.

In the case where the first ferrule 50, the second ferrule 60, or the third ferrule 90 has a cylindrical shape, the corresponding through-hole may be concentric with respect to the outer shape and may extend linearly. Accordingly, the optical axis can be adjusted without taking into consideration the position of the through-hole with respect to the outer shape and the extending direction of the through-hole.

The first optical fiber collimator 10, the second optical fiber collimator 20, the first optical fiber 30, or the second optical fiber 40 positioned within the corresponding through-hole may be secured by using the adhesive 101.

The second end surface 52 and the fourth end surface 62 may have a shape with a combination of a slope surface inclined relative to the first direction and a flat surface orthogonal to the first direction. Accordingly, when the element 100 is to be disposed at the second end surface 52 or the fourth end surface 62, the installation location can be visually confirmed.

A second other-end surface 53 and a fourth other-end surface 63 may intersect the direction orthogonal to the first direction. Alternatively, each of the second other-end surface 53 and the fourth other-end surface 63 may be tapered to widen toward the end surface or may have a chamfered edge at an opening. Accordingly, for example, an optical fiber collimator or an optical fiber can be readily inserted into the first through-hole 51 or the second through-hole 62.

In a case where another optical component is to be connected at the fourth other-end surface 63, the fourth other-end surface 63 may have a chamfered edge at the end surface or may be a curved surface with the second through-hole 61 serving as the center of the protrusion. Accordingly, an optical fiber of an external optical component and the second optical fiber 40 can readily come into contact with each other, as compared with a case where the fourth other-end surface 63 intersects with the first direction. The optical module 1001 having such a configuration has excellent connection reliability.

For example, each of the opposite end surfaces of the third ferrule 90 may be tapered to widen toward the end surface or may have a chamfered edge at the opening. Accordingly, for example, an optical fiber collimator or an optical fiber can be readily inserted into the third through-hole 91.

The first ferrule 50, the second ferrule 60, and the third ferrule 90 may be composed of, for example, a zirconia ceramic material, an alumina ceramic material, or glass. A ferrule composed of a zirconia ceramic material has excellent abrasion resistance and excellent machining accuracy. A ferrule composed of glass enables visual confirmation of whether, for example, an optical fiber collimator or an optical fiber located within a through-hole is properly positioned.

In the case where the optical module 1001 further includes the receptacle 80, the optical module 1001 may further retain a first holder 54 that holds the outer periphery of the first ferrule 50 and a second holder 64 that holds the outer periphery of the second ferrule 60.

Through-holes in the first holder 54 and the second holder 64 may have a cylindrical shape. When the first holder 54 and the second holder 64 are cylindrical, if the first ferrule 50 and the second ferrule 60 are also cylindrical, the connection strength between the first holder 54 and the first ferrule 50 and the connection strength between the second holder 64 and the second ferrule 60 can be increased. As a result, misalignment of the optical axis caused by loose connections between the first holder 54 and the first ferrule 50 and between the second holder 64 and the second ferrule 60 can be reduced, whereby the optical module 1001 having such a configuration has excellent connection reliability.

For example, the first holder 54 and the second holder 64 may have an outer diameter ranging between ϕ1 mm and ϕ6 mm and a length, in the optical-axis direction, ranging between 4 mm and 10 mm.

The first holder 54 and the second holder 64 may contain stainless steel, metal, such as stainless steel, or resin, such as polybutylene terephthalate (PBT). In the case where the first holder 54 and the second holder 64 contain stainless steel, an effect of deformation caused by stress received from the outside can be reduced, so that an optical coupling loss can be reduced.

[Sleeves]

The first sleeve 70 may have a cylindrical shape. In the case where the first sleeve 70 is cylindrical, a split sleeve having a slit 72 extending in the coaxial direction may be used as the first sleeve 70. By using a split sleeve, the first ferrule 50 and the second ferrule 60 can be readily retained by an elastic force. In addition, the resin material 71 can be injected through the slit 72.

The first sleeve 70 may have an inner diameter that is smaller than the outer diameter of the first ferrule 50 and the second ferrule 60 by about 0.005 mm or smaller. Furthermore, for example, the first sleeve 70 may have a thickness of 0.1 mm to 0.5 mm and a length of 2 mm to 5 mm in the first direction.

The first sleeve 70 may be composed of a zirconia ceramic material. The first sleeve 70 composed of a zirconia ceramic material has excellent abrasion resistance and can be machined into a desired shape with high accuracy.

The first ferrule 50 and the second ferrule 60 may be connected to the first sleeve 70 by fitting and securing the first ferrule 50 and the second ferrule 60 into the opposite ends of the first sleeve 70.

Alternatively, the first ferrule 50 and the second ferrule 60 may be connected to the first sleeve 70 by fitting the first ferrule 50 and the second ferrule 60 into the first sleeve 70 and securing the ferrules using the adhesive 101.

[Receptacle]

The receptacle 80 is used for connecting the optical module 1001 to an external optical component. The receptacle is constituted of a second sleeve 81, a sleeve casing 82, and a third sleeve 83.

The second sleeve 81 retains the second ferrule 60 and a ferrule that another optical component has. The second sleeve 81 may have a cylindrical shape. For example, the second sleeve 81 may have an outer diameter of ϕ1.5 mm to ϕ3.5 mm, an inner diameter of ϕ0.8 mm to ϕ2.5 mm, and a length of 2 mm to 8 mm in the first direction.

The second sleeve 81 may be composed of, for example, a zirconia ceramic material. The second sleeve 81 composed of a zirconia ceramic material has excellent abrasion resistance and can be machined into a desired shape with high accuracy.

The sleeve casing 82 is used for holding the outer periphery of the second sleeve 81. The sleeve casing 82 may have, for example, a cylindrical shape. For example, the sleeve casing 82 may have an outer diameter of ϕ2.5 mm to ϕ5 mm, an inner diameter of ϕ1.8 mm to ϕ4 mm, and a length of 3 mm to 7 mm in the first direction.

The sleeve casing 82 may be composed of metal, such as stainless steel, or resin, such as PBT. In the case of stainless steel, the sleeve casing 82 is less likely to deform against stress received from the outside, so that an optical loss is small.

The third sleeve 83 is used for connecting the first holder 54 and the second holder 64. The third sleeve 83 may be positioned to hold the outer periphery of the first holder 54. The third sleeve 83 may be composed of, for example, stainless steel, metal, such as stainless steel, or resin, such as PBT. In the case of stainless steel, the third sleeve 83 is less likely to deform against stress received from the outside, so that an optical loss is small.

The first holder 54 and the third sleeve 83 may be secured to each other by using the adhesive 101. Alternatively, the first holder 54 and the third sleeve 83 may be connected by yttrium aluminum garnet (YAG) welding.

The second holder 64 and the third sleeve 83 may be aligned with each other and be subsequently connected to each other by connecting an end surface of the second holder 64 and an end surface of the third sleeve 83 by using the adhesive 101.

[Element]

The element 100 may be, for example, an isolator element or a wavelength filter. In the case of an isolator element, a polarization-dependent isolator element or a polarization-independent isolator element may be used.

When the element 100 is to be bonded to the first surface 15, the second surface 25, the third surface 17, or the fourth surface 27, acrylic resin or epoxy resin may be used.

In a case where the element 100 used is an isolator element containing bismuth-substituted garnet with Tb, Gd, and Ho as additives or yttrium iron garnet (YIG), the element 100 may include a magnet 103 so that a magnetic field is applied to a Faraday rotator. Accordingly, the Faraday rotator can exhibit a Faraday effect.

The magnet 103 may be of a samarium cobalt (SmCo) type. With a SmCo type, the Curie temperature is high, so that the heat resistance is high, whereby the magnetic properties of the magnet 103 are less likely to deteriorate even when heat treatment is performed.

[Embodiment of Optical Unit]

An optical unit 1000 shown in FIG. 13 includes the optical module 1001 and an external substrate 1002 connected to the optical module 1001.

The external substrate 1002 may be formed from silicon photonics. In the case where the external substrate 1002 is formed from silicon photonics, the optical module 1001 and the external substrate 1002 may be connected by connecting the first optical fiber 30 and the external substrate 1002 to each other by using the adhesive 101. With the external substrate 1002 being connected to the first optical fiber 30, light from a light source, such as an LD, disposed on the external substrate 1002 enters the optical module 1001 via the first optical fiber 30, so that the degree of freedom in terms of the disposition of the LD can be enhanced.

Although the embodiments have been described above, the present disclosure is not to be limited to the above-described embodiments. Specifically, various modifications and combinations of embodiments are permissible so long as they do not depart from the scope of the present disclosure.

### REFERENCE SIGNS LIST

1000 optical unit

1001 optical module

1002 external substrate

10 first optical fiber collimator

11 first core

12 first cladding layer

13 first end surface

14 first other-end surface

15 first surface

16 first transparent member

17 third surface

20 second optical fiber collimator

21 second core

22 second cladding layer

23 third end surface

24 third other-end surface

25 second surface

26 second transparent member

27 fourth surface

30 first optical fiber

31 third core

32 fifth end surface

40 second optical fiber

41 fourth core

42 sixth end surface

50 first ferrule

51 first through-hole

52 second end surface

53 second other-end surface

54 first holder

60 second ferrule

second through-hole

62 fourth end surface

63 fourth other-end surface

64 second holder

70 first sleeve

71 resin material

72 slit

80 receptacle

81 second sleeve

82 sleeve casing

83 third sleeve

90 third ferrule

91 third through-hole

92 hole

100 element

101 adhesive

102 coating

103 magnet

1. An optical module comprising:
a first optical fiber;
a first optical fiber collimator;
a second optical fiber collimator; and
a second optical fiber that are sequentially arranged in a first direction as a direction of a light path,
wherein the first optical fiber collimator has a first core and a first cladding layer surrounding an outer periphery of the first core,
wherein the second optical fiber collimator has a second core positioned away from the first core and a second cladding layer surrounding an outer periphery of the second core,
wherein the first optical fiber has a third core,
wherein the second optical fiber has a fourth core,
wherein the third core has a core diameter smaller than a core diameter of the fourth core, and
wherein a difference between a refractive index of the first core and a refractive index of the first cladding layer is larger than a difference between a refractive index of the second core and a refractive index of the second cladding layer.

2. An optical module comprising:
a first optical fiber;
a first optical fiber collimator;
a second optical fiber collimator; and
a second optical fiber that are sequentially arranged in a first direction as a direction of a light path,
wherein the first optical fiber collimator has a first core and a first cladding layer surrounding an outer periphery of the first core,
wherein the second optical fiber collimator has a second core positioned away from the first core and a second cladding layer surrounding an outer periphery of the second core,
wherein the first optical fiber has a third core,
wherein the second optical fiber has a fourth core,
wherein the third core has a core diameter larger than a core diameter of the fourth core, and
wherein a difference between a refractive index of the first core and a refractive index of the first cladding layer is smaller than a difference between a refractive index of the second core and a refractive index of the second cladding layer.

3. The optical module according to claim 1,
wherein the first core and the third core are in contact with each other, and
wherein the second core and the fourth core are in contact with each other.

4. The optical module according to claim 3,
wherein a diameter D1 of the first optical fiber in a direction orthogonal to the first direction and a diameter D2 of the first optical fiber collimator in the direction orthogonal to the first direction are at a minimum at a boundary between the first optical fiber and the first optical fiber collimator.

5. The optical module according to claim 3 or 4,
wherein a diameter D3 of the second optical fiber collimator in a direction orthogonal to the first direction and a diameter D4 of the second optical fiber in the direction orthogonal to the first direction are at a minimum at a boundary between the second optical fiber collimator and the second optical fiber.

6. The optical module according to claim 1, further comprising:
a first ferrule having a first through-hole; and
a second ferrule having a second through-hole,
wherein the first optical fiber is positioned within the first through-hole, and the second optical fiber is positioned within the second through-hole.

7. The optical module according to claim 6,
wherein the first optical fiber collimator is further positioned within the first through-hole, and
wherein the second optical fiber collimator is further positioned within the second through-hole.

8. The optical module according to claim 7,
wherein the first optical fiber collimator has a first end surface at a front side in the first direction,
wherein the first ferrule has a second end surface at the front side in the first direction,
wherein the second optical fiber collimator has a third end surface at a rear side in the first direction,
wherein the second ferrule has a fourth end surface at the rear side in the first direction, and
wherein the first end surface and the second end surface are a common first surface, and the third end surface and the fourth end surface are a common second surface.

9. The optical module according to claim 7,
wherein the first optical fiber collimator has a first end surface located at a front side in the first direction and a first transparent member that is in contact with the first end surface,
wherein the first ferrule has a second end surface at the front side in the first direction,
wherein the second optical fiber collimator has a third end surface at a rear side in the first direction and a second transparent member that is in contact with the third end surface,
wherein the second ferrule has a fourth end surface at the rear side in the first direction, and
wherein the second end surface and an end surface of the first transparent member are a common third surface, and the fourth end surface and an end surface of the second transparent member are a common fourth surface.

10. The optical module according to claim 9,
wherein the third surface is inclined relative to a direction orthogonal to the first direction.

11. The optical module according to claim 9,
wherein the fourth surface is inclined relative to a direction orthogonal to the first direction.

12. The optical module according to claim 9,
wherein the third surface and the fourth surface are parallel to each other.

13. The optical module according to claim 6, further comprising:
a first sleeve,
wherein the first ferrule and the second ferrule are positioned away from each other within the first sleeve.

14. The optical module according to claim 13,
wherein a resin material is positioned within the first sleeve, and
wherein the resin material is positioned between the first ferrule and the second ferrule and on the light path between the first core and the second core.

15. The optical module according to claim 6, further comprising:
a receptacle that retains the second ferrule.

16. The optical module according to claim 1, further comprising:
a third ferrule having a third through-hole,
wherein the first optical fiber, the first optical fiber collimator, the second optical fiber collimator, and the second optical fiber are positioned within the third through-hole, and
wherein the third ferrule has a hole connecting to the third through-hole and located between the first optical fiber collimator and the second optical fiber collimator.

17. The optical module according to claim 1, further comprising:
an element that is positioned on the light path between the first core and the second core.

18. The optical module according to claim 9, further comprising:
an element that is positioned on the light path between the first core and the second core and is positioned on the third surface or the fourth surface.

19. An optical unit comprising:
the optical module according to claim 1; and
an external substrate connected to the optical module.
